(19) United States
(12) Patent Application Publication
(10) Pub. No.: US 2010/0136369 A1
(43) Pub. Date: Jun. 3, 2010

(54) High strength and toughness steel structures by friction stir welding

(76) Inventors: Raghavan Ayer, Basking Ridge, NJ (US); Douglas Paul Fairchild, Sugar Land, TX (US); Steven Jeffrey Ford, Missouri City, TX (US); Hyun-Woo Jin, Easton, PA (US); Adnan Ozekcin, Bethlehem, PA (US)

Correspondence Address: ExxonMobil Research and Engineering Company, P. O. Box 900, Annandale, NJ, 08801-0900, US

(21) Appl. No.: 12/590,956

(22) Filed: Nov. 17, 2009

Related U.S. Application Data
(60) Provisional application No. 61/199,557, filed on Nov. 18, 2008.

(51) Int. Cl. B32B 15/01; B23K 20/12

(52) U.S. Cl. 428/683; 228/112.1

(57) ABSTRACT

Provided are steel structures methods of making such steel structures including structural steel components bonded by friction stir weldments with advantageous microstructures to yield improved weldment strength and weldment toughness. In one form of the present disclosure, the steel structure includes: two or more structural steel components produced by conventional melting or secondary refining practices and friction stir weldments bonding faying surfaces of the components together, wherein the chemistry and grain size of the starting structural steel satisfies one or more of the following criteria: a) 0.02 wt %<Ti+Nb<0.12 wt %, b) 0.7<Ti/N<3.5, c) 0.5 wt %<Mo+W+Cr+Cu+Co+Ni<1.75 wt %, d) 0.01 wt %<TiN+NbC+TiO/MgO<0.1 wt %, e) average grain size of at least 2 microns, wherein the friction stir weldments have a prior austenite grain size of between 5 and 60 microns and less than 50 vol % of martensite-austenite constituent, and wherein the friction stir weldment strength is greater than the starting structural steel and the friction stir weldment toughness as measured by the crack tip opening displacement test at less than or equal to 0° C. is greater than or equal to 0.05 mm or by the Charpy V-notch impact test at less than or equal to 0° C. is greater than 40 J. The steel structures find application in linepipe for oil and gas production.

### CROSS-REFERENCE TO RELATED APPLICATIONS

This application claims priority to U.S. Provisional Application Ser. No. 61/199,557 filed Nov. 18, 2008, herein incorporated by reference in its entirety.

### FIELD

The present disclosure relates generally to steel chemistry and structures. More specifically, the disclosure relates to steel chemistry and structures with friction stir weldments. Still more specifically, the present disclosure relates to steel chemistry and structures with friction stir weldments exhibiting advantageous strength and toughness properties.

### BACKGROUND

The joining of metal parts such as formed shapes, forgings, castings, or plates to construct any number of structures or components for a variety of industries is largely performed by fusion welding. For example, construction using pipes and tubes to form pipelines for oil, gas and geothermal wells and the like is largely performed by conventional arc or fusion welding. For decades, the pipeline industry has made wide use of several fusion welding technologies such as shielded metal arc welding (SMAW) and mechanized gas metal arc welding (GMAW) for pipeline construction. There have been considerable efforts for developing weld consumables and welding procedures that provide suitable properties of the weldment (e.g., overmatch, toughness).

Arc or fusion welding involves melting of the materials being welded to create the joint. In such a process the larger the pipe diameter, or the thicker the wall of the pipe, the slower the welding becomes because a greater volume of metal must be melted and deposited in the weld joint. For onshore pipelines, particularly in remote areas, it is important that the welding be as economic as possible because of the large expense related to deployment of workers and equipment to the pipeline right of way (ROW). For offshore pipelines, it is important that the welding be as economic as possible because of the substantial costs associated with the laybarge. In welding and placing into service pipes for either onshore or offshore pipelines, there can be significant stresses resulting from many sources. For example, during laybarge operations, the completed pipeline hanging from the laybarge can produce large bending stresses. Pipelines may have to support ground movements in addition to containing the internal pressure. In addition, conventional fusion welded joints can suffer heat related damage that degrades the mechanical integrity of the joints. Examples of such attributes are tensile residual stress, hydrogen cracking, lack of fusion defects and low toughness.

Girth welds of linepipe steels using the well established fusion welding processes typically consists of 3-20 passes of weld beads depending on the thickness of the pipe. During a standard onshore pipeline construction process, joining is accomplished by having about as many welding stations as there are number of weld passes, each station designed to produce one or two specific weld passes, which limits the welding speed. The entire process, therefore, requires considerable manpower and associated expenses to house them, particularly in remote locations and also time, which impacts pipeline construction costs.

In the case of high carbon content steels, such as casing steels that have a CE in the range of about 0.48 to 1.00, current welding practice requires preheating the work pieces to 100-400° C. and forming the weld with low hydrogen practices. Such procedures are necessary to minimize the formation of a hard HAZ and absorption of weld related hydrogen which cause susceptibility to cracking. Because of the difficulties associated with such a welding technique, often high carbon steel work pieces are mechanically joined instead using various types of couplings.

Conventional fusion welds can exhibit cracks in both the weld metal or in the HAZ, these cracks being created during welding or after some period of service. Hard and low toughness regions of the weldment, especially the HAZ, can be prone to develop cracks in service particularly when the welded component is used in sour service or other aggressive process environments. In the case of the petrochemical industry where thousands of miles of pipes are installed each year to transport gas, oil and fluids, the costs for repairs are significant. It is essential that these cracks are repaired before they grow to a critical dimension when they can propagate catastrophically.

Friction stir welding (FSW) has been recognized and utilized for welding of low melting materials such as aluminum alloys. The application of FSW to joining of steels and other high melting temperature materials has been limited primarily by the absence of a suitable tool material which can operate at high temperatures, in the range of 1000˜1400° C. As a result, much recent FSW work in the area of joining steels has concentrated on tool development. Very little work has been directed to understanding the microstructure of friction stir welds in steel to achieve mechanical properties suitable for structural applications. Similarly, essentially no work has been identified that explains the effects of base steel chemistry and microstructure on the FSW joint properties, specifically strength and toughness.

In the oil and gas industry, potential applications for FSW include the fabrication of pipelines, ships, pressure vessels, storage tanks, and offshore structures. FSW is potentially useful in any application where large amounts of welding are necessary and there is an incentive for using high heat input welding procedures, faster welding processes, or a reduction in the number of welding passes. However, in order for FSW to compete with the well established fusion welding processes for this application, several challenges have to be overcome. One of the major challenges in establishing the technical viability of FSW for pipeline joining is the achievement of the required strength and toughness in the joint. In conventional fusion welding, the target properties of the joint are achieved through the design of weld metal chemistry and weld procedure including careful selection of welding consumables like welding wire, shielding gas, and/or welding flux. In FSW, the freedom to choose an independent weld metal chemistry is essentially lost and the properties have to be achieved through the thermo-mechanical processing of the base metal. In this regard, there is need for methods to formulate optimum structural steels to be compatible with FSW. In order to achieve acceptable strength and toughness properties, the base metals to be used with FSW can be melted or subjected to secondary refining by conventional practices, including, but not limited to, using an electric arc furnace, a vacuum furnace, a blast furnace, or a basic oxygen furnace, but require proper selection of chemistry, processing and grain size. Many structural steels have grain sizes of 20 to 75 microns. Steels with greater degrees of processing have grain sizes ranging from 10 to 20 microns. More advanced thermomechanical control processing (TMCP) treatments are capable of producing base metal grain sizes of 5 to 10 microns. Still more aggressive TMCP treatments are capable of creating base metals with grain sizes in the range of 1 to 5 microns. Depending on the final application of the base metal and friction stir weldments, the starting grain size can be selected and mated to a proper FSW procedure to yield the desired properties.

Hence, there is a need for new efficient welding techniques to fabricate steel structures. This includes structures fabricated using friction stir welding with improved weldment strength and toughness. There is also need for a faster, simpler and less capital intensive methods for welding steel structures, and in particular for pipeline construction to reduce pipeline construction costs. There is also a need for methods of formulating and producing base metals to be compatible with friction stir welding and selecting specific base metals depending on the end application of the friction stir welded fabrication.

### DEFINITIONS

For convenience, various structural steel and welding terms used in this specification and claims are defined below.

Acceptable weldment strength: Strength level that is consistently above that of the base steel.

Acceptable weldment toughness: A toughness of greater than 0.05 mm, as measured by the crack-tip opening displacement (CTOD) test at less than or equal to 0° C.

HAZ: Heat-affected-zone.

Heat-affected-zone: Base metal that is adjacent to the weld line and that was affected by the heat of welding.

Toughness: Resistance to fracture.

Fatigue resistance: Resistance to fracture (crack initiation and propagation) under cyclic loading.

Yield strength: That strength corresponding to load support without permanent deformation.

FS: Friction stir.

FSW: Friction stir welding.

Friction stir welding: A solid state joining process for creating a welded joint between two work pieces in which the heat for joining the metal work pieces is generated by plunging a rotating tool between the work pieces and traversing the tool along the faying surfaces.

FSP: Friction stir processing.

Friction stir processing: The method of processing and conditioning the surface of a structure by pressing a FSW tool against the surface by partially plunging a pin into the structure.

Grain size: A measure of basic microstructural unit size where each unit possesses a significantly different crystallographic orientation and/or basic microstructure as compared to neighboring units. Grain size, as used herein, refers to the average grain size of a metal which can be measured by one of several techniques known to those skilled in the art of metallurgy. One such technique is described in ASTM E1382.

Weld joint: A welded joint including the fused or thermo-mechanically altered metal and the base metal in the “near vicinity” of, but beyond the fused metal. The portion of the base metal that is considered within the “near vicinity” of the fused metal varies depending on factors known to those skilled in the art of welding engineering.

Weldment: An assembly of component parts joined by welding.

Weldability: The feasibility of welding a particular metal or alloy. A number of factors affect weldability including chemistry, surface finish, heat-treating tendencies, the propensity of defect formation, and the like.

Carbon equivalent: A parameter used to define weldability of steels and expressed by the formula CE=C+Mn/6+(Cr+Mo+V)/5+(Ni+Cu)/15 where all units are in weight percent.

Hydrogen cracking: Cracking that occurs in the weld subsequent to welding and is caused by absorbed hydrogen, stresses such as residual stresses, and the presence of a susceptible microstructure like martensite.

TMAZ: Thermo-mechanically affected zone.

Thermo-mechanically affected zone: Region of a FSW joint that has experienced both temperature cycling and plastic deformation.

TMAZ-HZ: TMAZ-hard zone, the hardest region in a FSW weldment.

Duplex: Stainless steel consisting of two phases, specifically austenite and ferrite.

Structural steel: Steel subjected to some type of mechanical load during use.

Martensite austenite constituent (MA): Remnant areas of microstructure in a ferritic steel or weld that transform on cooling to a mixture of martensite and retained austenite. These areas are often the last regions to transform on cooling. MA regions are stabilized due to carbon rejection from surrounding areas that have already transformed at higher temperatures. Due to stabilization, the transformation of austenite to MA occurs at lower temperatures than the surrounding areas. Regions of MA are typically dominated by martensite while only containing small volume fractions of retained austenite (less than 10%). MA is often seen on prior austenite grain boundaries of welds or HAZs that experience double thermal cycles. MA is also found on lath boundaries in the lath based microstructures of degenerate upper bainite and lower bainite. MA is typically observed on any number of lath, packet or grain boundaries present in structural steels.

Acicular ferrite (AF): AF is often the first decomposition product to transform in a steel weld from the austenite during cooling, although proeutectoid ferrite (polygonal ferrite) can sometimes form first. AF nucleates on small, non-metallic inclusions and then experiences rapid growth by a bainitic-type transformation mechanism. The AF grains typically exhibit a needle-like morphology with aspect ratios ranging from about 2:1 to 20:1 depending on cooling rate and chemistry. This transformation involves both shear and diffusional components. The transformation temperature controls the interplay between the diffusional and shear components, thus determining AF morphology.

Granular bainite (GB): Refers to a cluster of 3 to 5 relatively equiaxed bainitic ferrite grains that surround a centrally located, small “island” of Martensite-Austenite (MA). Typical “grain” diameters are about 1-2 μm.

Upper bainite (UB): Refers to a mixture of acicular or laths of bainitic ferrite interspersed with stringers or films of carbide phase such as cementite. Most common in steels with carbon contents higher than about 0.15 wt %.

Degenerate upper bainite (DUB): A bainitic product where each colony grows by shear stress into a set (packet) of parallel laths. During and immediately after lath growth, some carbon is rejected into the interlath austenite. Due to the relatively low carbon content, carbon enrichment of the entrapped austenite is not sufficient to trigger cementite plate nucleation. Such nucleation does occur in medium and higher carbon steels resulting in the formation of classical upper bainite (UB). The lower carbon enrichment at the interlath austenite in DUB, results in formation of martensite or martensite-austenite (MA) mixture or can be retained as retained austenite (RA). DUB can be confused with classical upper bainite (UB). UB of the type first identified in medium carbon steels decades ago consists of two key features; (1) sets of parallel laths that grow in packets, and (2) cementite films at the lath boundaries. UB is similar to DUB in that both contain packets of parallel laths; however, the key difference is in the interlath material. When the carbon content is about 0.15-0.40, cementite (Fe₃C) can form between the laths. These “films” can be relatively continuous as compared to the intermittent MA in DUB. For low carbon steels, interlath cementite does not form; rather the remaining austenite terminates as MA, martensite or RA.

Lower bainite (LB): LB has packets of parallel laths similar to DUB. LB also includes small, intra-lath carbide precipitates. These plate-like particles consistently precipitate on a single crystallographic variant that is oriented at approximately 55° from the primary lath growth direction (long dimension of the lath).

Lath martensite (LM): LM appears as packets of thin parallel laths. Lath width is typically less than about 0.5 μm. Untempered colonies of martensitic laths are characterized as carbide free, whereas auto-tempered LM displays intra-lath carbide precipitates. The intralath carbides in autotempered LM form on more than one crystallographic variant, such as on {110} planes of martensite. Often the cementite is not aligned along one direction, rather it precipitates on multiple planes.

Tempered martensite (TM): TM refers to the heat treated form of martensite in steels whereby the heat treatment is performed in furnace or by local means such as using heating wrap. This form of tempering is conducted after welding fabrication. The microstructure and mechanical properties change as the metastable structure martensite incurs the precipitation of cementite during excursions in a temperature range where cementite precipitation is possible, but too low for austenite formation.

Auto-tempered lath martensite: Martensite that incurs self-tempering during cooling from an operation such as welding. Cementite precipitation occurs in-situ, on cooling, and without reheating as is done for traditional tempering.

Pearlite: Typically a lamellar mixture of two-phases, made up of alternate layers of ferrite and cementite (Fe₃C). In low carbon structural steels, pearlite often appears in what is referred to as colonies meaning groupings of distinct pearlite areas that have common lamellae orientation.

Grain: An individual crystal in a polycrystalline material.

Grain boundary: Refers to a narrow zone in a metal corresponding to the transition from one crystallographic orientation to another, thus separating one grain from another.

Grain coarsening temperature differential: The temperature range between the A3 temperature and a temperature at which rapid grain growth occurs. The temperature at which rapid grain growth occurs depends on the steel's chemistry and microstructure and on the amount of time spent at high temperatures.

Prior austenite grain size: Refers to the average austenite grain size that existed before the steel component cools into the temperature range where lower temperature transformation products such as AF, GB, DUB, LB, or LM evolve.

### SUMMARY

Provided are steel structures including structural steel components bonded by friction stir weldments with advantageous microstructures to yield improved weldment strength and weldment toughness. Also provided are methods of making such steel structures.

In one form of the current disclosure, an advantageous steel structure includes: two or more structural steel components produced by conventional melting or secondary refining practices and friction stir weldments bonding faying surfaces of the components together, wherein the chemistry and grain size of the starting structural steel satisfies one or more of the following criteria:
a) 0.02 wt %<Ti+Nb<0.12 wt %,
b) 0.7<Ti/N<3.5,
c)0.5 wt %<Mo+W+Cr+Cu+Co+Ni<1.75 wt %,
d) 0.01 wt %<TiN+NbC+TiO/MgO<0.1 wt %,
e) average grain size of at least 2 microns,
   wherein the friction stir weldments have a prior austenite grain size of between 5 and 60 microns and less than 50 vol % of martensite-austenite constituent, and wherein the friction stir weldment strength is greater than the starting structural steel and the friction stir weldment toughness as measured by the crack tip opening displacement test at less than or equal to 0° C. is greater than or equal to 0.05 mm or by the Charpy V-notch impact test at less than or equal to 0° C. is greater than 40 J.

In another form of the current disclosure, an advantageous method for welding structural steel includes: providing two or more structural steel components produced by conventional melting or secondary refining practices, wherein the chemistry and grain size of the starting structural steel satisfies one or more of the following criteria:
a) 0.02 wt %<Ti+Nb<0.12 wt %,
b) 0.7<Ti/N<3.5,
c) 0.5 wt %<Mo+W+Cr+Cu+Co+Ni<1.75 wt %,
d) 0.01 wt %<TiN+NbC+TiO/MgO<0.1 wt %,
e) average grain size of at least 2 microns,
   subjecting the faying surfaces of the structural steel components to be welded to friction stir welding under conditions sufficient to form friction stir weldments, wherein the friction stir weldments have a prior austenite grain size of between 5 and 60 microns and less than 50 vol % of martensite-austenite constituent, and wherein the friction stir weldment strength is greater than the starting structural steel and the friction stir weldment toughness as measured by the crack tip opening displacement test at less than or equal to 0° C. is greater than or equal to 0.05 mm or by the Charpy V-notch impact test at less than or equal to 0° C. is greater than 40 J.

These and other forms of the disclosed steel structures and methods for welding structural steels of the present disclosure and their advantageous applications and/or uses will be apparent from the detailed description which follows, particularly when read in conjunction with the figures appended hereto.

### BRIEF DESCRIPTION OF THE DRAWINGS

To assist those of ordinary skill in the relevant art in making and using the subject matter hereof, reference is made to the appended drawings, wherein:

FIG. 1 is a schematic illustration of the method of joining two tubular structural steel components by friction stir welding.

FIG. 2 is a diagram showing the use of a metallic shim in joining two tubular structural steel components by friction stir welding.

FIG. 3 depicts the friction stir weld tool parts (pin and shoulder) for joining two tubular structural steel components by friction stir welding.

FIG. 4 depicts at the top the cooling and heating of a structural steel as a friction weld tool passes over it from right to left and correspondingly at the bottom depicts the temperature and plastic strain of the structural steel as a function of time.

FIG. 5 depicts the variation in CTOD toughness in the stir zone in the FSW joints produced by two commercial linepipe steel plates.

FIG. 6 depicts the solvus temperature of NbC as a function of Nb and C content.

FIG. 7 depicts TEM micrographs exhibiting the base metal microstructure with (a) fine (˜10 nm) Nb(C,N) precipitates in Steel 1, and (b) coarser (˜200 nm) Ti(C,N) precipitates in Steel 2.

FIG. 8 depicts SEM micrographs exhibiting the base metal microstructures of X80 steel with (a) Steel 3 (Inventive Steel), and (b) Steel 2 (Comparative Steel).

### DETAILED DESCRIPTION

All numerical values within the detailed description and the claims herein are modified by “about” or “approximately” the indicated value, and take into account experimental error and variations that would be expected by a person having ordinary skill in the art.

U.S. Patent Publication No. 20070175967, incorporated by reference herein in its entirety, discloses a method for welding and repairing cracks in metal parts is provided by subjecting the metal parts to be welded to friction stir welding and the cracks to be repaired to friction stir processing under conditions sufficient to provide a weld joint or crack repair having a preselected property or set of properties based upon the intended use of the weldment.

U.S. Patent Publication No. 20070181647, incorporated by reference herein in its entirety, discloses the use of friction stir processing and friction stir welding methods for joining and repairing metal structures and components in applications for natural gas transportation and storage, oil and gas well completion and production, and oil and gas refinery and chemical plants.

U.S. Patent Publication No. 20080032153, incorporated by reference herein in its entirety, discloses the use of friction stir and laser shock processing in oil & gas and/or petrochemical applications.

PCT Patent Publication No. WO2008/045631, incorporated by reference herein in its entirety, discloses a steel composition and method from making a dual phase steel therefrom. In one form, the dual phase steel comprises carbon in an amount of about 0.05% by weight to about 0.12 wt %; niobium in an amount of about 0.005 wt % to about 0.03 wt %; titanium in an amount of about 0.005 wt % to about 0.02 wt %; nitrogen in an amount of about 0.001 wt % to about 0.01 wt %; silicon in an amount of about 0.01 wt % to about 0.5 wt %; manganese in an amount of about 0.5 wt % to about 2.0 wt %; and a total of molybdenum, chromium, vanadium and copper less than about 0.15 wt %. The steel has a first phase consisting of ferrite and a second phase comprising one or more constituents selected from the group consisting of carbide, pearlite, martensite, lower bainite, granular bainite, upper bainite, and degenerate upper bainite.

Japanese Patent Publication No. JP2008-31494, incorporated by reference herein in its entirety, discloses low alloy structural steels with designed chemistry for an enlarged ferrite region and a mixed two phase (ferrite+austenite) region at temperatures above 600° C. or reduced austenite phase region in an equilibrium phase diagram formed by adding ferrite stabilizing elements such as Si (0.4%˜4%), Al (0.3%˜3%), Ti (0.3%˜3%) and/or combination thereof.

### Overview:

Provided herein are steel structures and methods of making such steel structures which include structural steel components produced by conventional melting or secondary refining practices bonded by friction stir weldments with advantageous microstructures to yield improved weldment strength and weldment toughness. The steel structures and methods of making such steel structures disclosed herein provide for “acceptable” strength and toughness in the friction stir weldments. The steel structures and methods of making such steel structures teach the range of structural steel chemistries, initial structural steel microstructures including grain size, and friction stir processing parameters needed to achieve this combination of acceptable weldment strength and weldment toughness.

The steel structures and methods of making such steel structures disclosed herein find utility in a broad range of applications for carbon and alloys steels, and in particular for linepipes in the oil and gas industry. Other applications include the fabrication of pipelines, ships, pressure vessels, storage tanks, and offshore structures. The steel structures and methods of making such steel structures disclosed herein are also useful in applications where large amounts of welding are necessary and there is an incentive for using high heat input welding procedures, faster welding processes, or a reduction in the number of welding passes. Non-limiting exemplary advantages of the steel structures and methods of making such steel structures utilizing friction stir welding disclosed herein include reduced fabrication costs compared to fusion welds, reduced weldment defects compared to fusion welds, reduced NDE requirements, reduced repair cost, and reduced need for skilled labor.

### Friction Stir Welding Process:

Friction Stir Welding (FSW) is a solid-state joining technology which does not involve melting and solidification as does fusion welding. During friction stir welding, a rotating tool is used to weld the two-different workpieces together by generating the heat through friction and plasticization. A non-consumable rotating tool is pushed into the materials to be welded and then the central pin, or probe, followed by the shoulder, is brought into contact with the two parts to be joined. The rotation of the tool heats up and causes the material of the work pieces to soften into a plastic state without reaching the melting point of workpiece material. As the tool moves along the joint line, material from the front of the tool is swept through this plasticized annulus to the rear, so eliminating the interface. Some material entering the plasticized region may progress around the rotating tool more than one revolution before exiting near the rear of the weld and then cooling to room temperature.

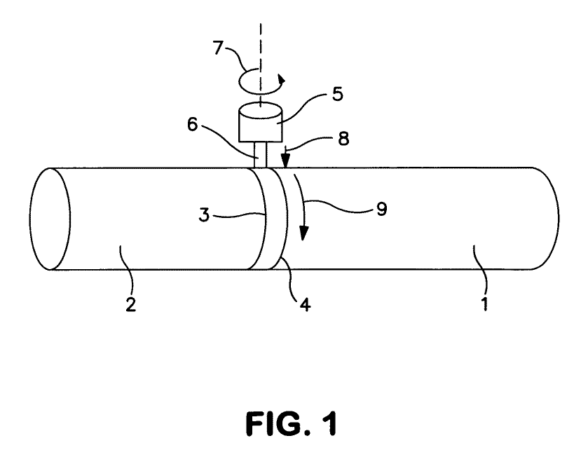

Referring to FIG. 1, there are shown two tubular work pieces 1 and 2 which are positioned so that their faying surfaces 3 and 4 are in contact with each other. The work pieces, 1 and 2, are to be welded to one another along their faying surfaces 3 and 4. As shown in FIG. 1, the friction stir weld (FSW) tool comprises a welding head with a shoulder 5 and a friction pin 6. The relative sizes or shapes of the shoulder and the pin can be changed to suit specific welding needs and a variety of geometries are suitable for this disclosure. The work pieces 1 and 2 are held together by mechanical means such as clamping so that the faying surfaces 3 and 4 are in physical contact with each other before the start and during welding. The friction stir welding head 5 is rotated as shown by arrow 7, plunged downwardly into the work pieces 1 and 3 as shown by arrow 8 and advanced circumferentially as indicated by arrow 9. For a single sided weld, the depth of tool plunge is essentially the thickness of the work pieces or components being welded. For double sided welding, such depth can be approximately half the thickness of the work pieces being welded. As a consequence, a circumferential weld is produced. The FSW tool may be composed of any tool material capable of high temperature joining, which includes ceramics, metallics, composites and other derivatives thereof.

In the case of repairing a surface-opening crack, for example in a tubular work piece, a similar procedure to that described in connection with FIG. 1 is employed except that the pin 6 is not plunged all the way into the work piece but only superficially and the direction of the advancing tool follows the contour of the crack. This is referred to as friction stir repair or friction stir processing as distinguished from friction stir welding. Repair and/or treatment are also referred to as processing.

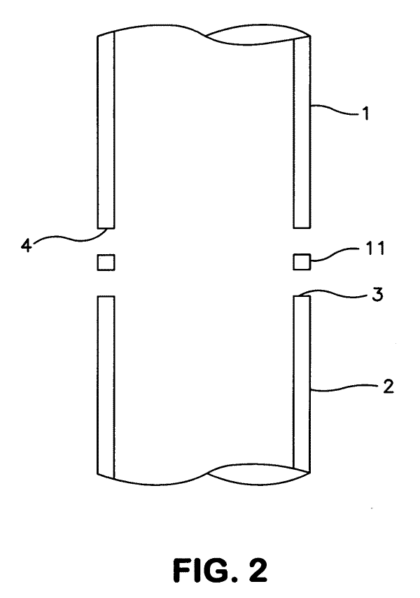

In the exemplary embodiment shown in FIG. 2, the work pieces 1 and 2 have a metal shim 11 interposed between the faying surface 3 and 4. The pieces are arranged so that the faying surfaces are in contact with shim 11. The FSW tool is advanced so as to form a weld incorporating the base metal of work pieces 1 and 2 and metal shim 11. This is referred to as friction stir welding as distinguished from friction stir repair or friction stir processing.

As will be readily appreciated, the work pieces (also referred to as structural steel components) described in the above embodiments can be formed of the same base metal (structural steel type) or they can be of different steel types. Similarly, the metal shim can be formed of the same metal as the work pieces for joining or it can be of a special alloy to enhance weld properties. Thus the structural steel components and the metal shim for friction stir welding can be formed of the same steel type or of differing materials depending on the application. The structural steels can be produced by conventional melting or secondary refining practices including, but not limited to, melting in a vacuum furnace, an electric arc furnace, a blast furnace, or a basic oxygen furnace, and typically have average base metal grain sizes from 2 microns to 100 microns. Non-limiting exemplary structural steels include API (American Petroleum Institute) Pipe Specification 5L pipe grades chosen from X50, X52, X60, X65, X70, X80, X90, X100 and X120 or higher strength steels. In yet another aspect, structural steels may include plain carbon and alloy steels including, but not limited to, AISI 1010, 1020, 1040, 1080, 1095, A36, A516, A440, A633, A656, 4063, 4340, 6150 and other AISI grades (including high strength grades). In still yet another aspect, structural steels may include ASTM grades A285, A387, A515, A516, A517 and other ASTM grades of carbon low alloy steels.

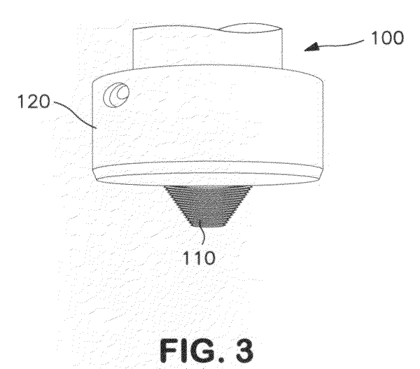

As shown in greater detail in FIG. 3, the FSW tool 100 includes two parts, a friction pin 110 and the tool shoulder 120. The shoulder 120 is a dominant means of generating heat during FSW and it prevents the material expulsion and assists material movement around the tool. The function of the friction pin 110 is to primarily deform the material around the tool and while its secondary function is to generate heat. The FSW tool used in FSW of aluminum generally has a cylindrical pin with several small features such as large plunge pressure limits the choice of tool materials and tool design. For welding of steel, a variable pin diameter tool made up of W—Re or PCBN may be advantageous. A variety of FSW tool geometries are compatible with this disclosure. This disclosure regards selection of base metal metallurgy for improving friction stir weld properties. The tool described herein creates the necessary thermo-mechanical cycle to which the base metal of the invention will respond favorably.

A defect free FSW may be produced by using the correct tool design and process parameters. These process parameters, include one or more of, but not limited to, the welding travel speed of the friction stir weld tool, the rotational speed of the friction stir weld tool, the torsion loads applied to the friction stir weld tool, the down force load or the translational load on the friction stir weld tool, and the cooling rate of the weldment. The tool design and the aforementioned process parameters affect the material flow, which may be controlled to compensate for the high strain rates and temperatures during processing.

The benefits of FSW are primarily derived from the following characteristics: (1) lower temperatures required to perform the joining compared to fusion welds and lower temperatures in the joint cause less detrimental effects both within the joint and in the adjoining base metal (e.g., coarse grains); (2) high degree of plastic deformation resulting from the rotation of the tool which results in fine grain size which is conducive to improved strength and toughness; and (3) avoidance of hydrogen embrittlement in weldments as compared to fusion welds, which are often prone to hydrogen embrittlement from the decomposition of the residual moisture in the arc.

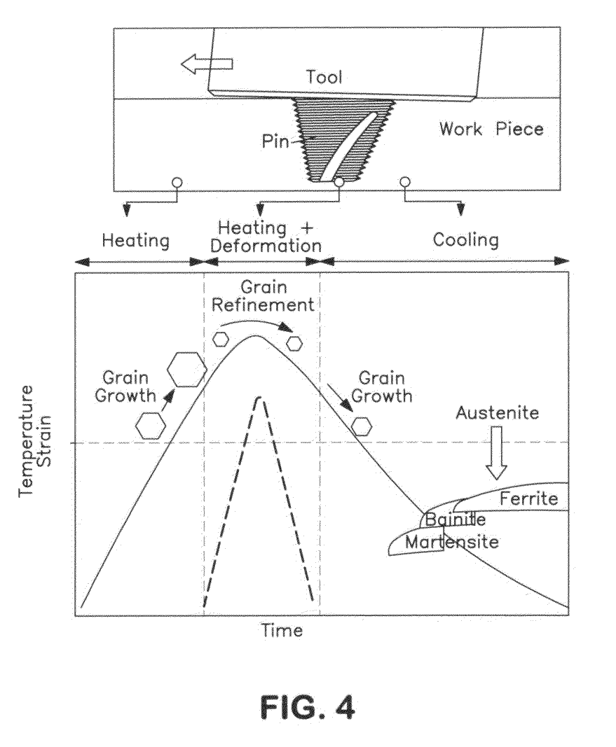

The difficulties in achieving both strength and toughness in the FSW joints when joining structural steels may be illustrated though the schematic of FIG. 4. FIG. 4 shows the temperature and strain excursions as the FSW tool passes any point in the joint during the FSW process. The solid line in the graph indicates the temperature variation while the dotted line in the graph indicates the variation of plastic strain. The horizontal dotted line indicates the transformation between ferrite and austenite. As the tool passes by, each point in the joint would experience three thermo-mechanical stages: Heating, Heating+Deformation, and finally Cooling. In this explanation, metallurgical changes are described for a hypothetical fixed point being monitored for changes in temperature and strain.

In the Heating stage, the temperature of the point increases before the tool arrives due to the thermal conduction from the heat generated from the deformation in the preceding region. The increase in temperature results in phase transformation from ferrite to austenite and growth of the austenite grains. In the second stage, when the tool arrives at the point, the grains undergo plastic deformation, resulting in grain refinement due to dynamic recrystallization. In the third stage, the dynamically recrystallized grains undergo static recovery and recrystallization and subsequent grain growth. The recrystallized grains finally transform during cooling to one or a mixture of possible microstructures including lath martensite, auto-tempered lath martensite, any of the various bainites such as granular bainite or degenerate upper bainite or lower bainite and/or martensite austenite constituent or retained austenite depending on the steel chemistry, processing conditions, beginning microstructure including grain size and the weld cooling rate.

Since the strength and toughness of the friction stir weldment or joint is a function of the joint microstructure, the FSW process parameters may be used to provide the target microstructure. Since the final microstructure is a resultant of all the thermo-mechanical processes that precede the final cooling, it is necessary to control the process parameters of the FSW method to ensure the achievement of target properties in the joint. The microstructure and mechanical properties of the friction stir welded joints disclosed herein depend on the chemistry, processing history, microstructure, and grain size of the base material (structural steel), as well as FSW processing parameters (the welding travel speed of the friction stir weld tool, the rotational speed of the friction stir weld tool, the torsion load applied to the friction stir weld tool, the down force load or the translational load on the friction stir weld tool, and the cooling rate of the weldment).

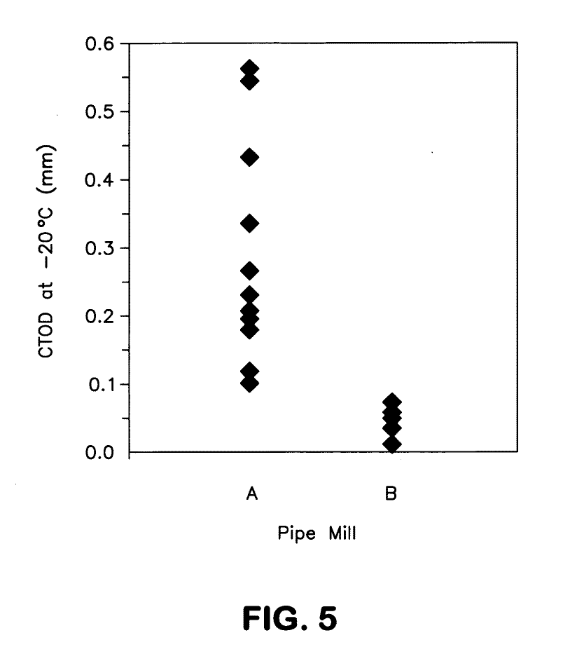

Hence, FSW joints of structural steels may have variable toughness, with some meeting the defined acceptability CTOD or Charpy V-notch targets and some not depending on the chemistry and microstructure of the base metal, and the FSW processing parameters. FIG. 5 depicts the variation in CTOD toughness in the stir zone in the FSW joints produced in two commercial linepipe steels. The primary origin of low weld toughness arises from an undesirable microstructure with large grain size and coarse bainite with high carbon Martensite-Austenite (MA) constituents. Therefore, there is a need to control the processing parameters of friction stir welding and base steel (steel chemistry, initial microstructure including grain size) so that the resultant joints have strength and toughness values that consistently meet the defined acceptable values. The steel structures and methods of making such steel structures disclosed herein have defined the range of these parameters to produce steel structures with friction stir welds that consistently meet or exceed the acceptability guidelines for weldment strength and toughness.

### Exemplary Steel Structures:

One form of the steel structure disclosed herein includes two or more structural steel components produced by conventional melting practices and friction stir weldments bonding faying surfaces of the components together, wherein the chemistry and grain size of the starting structural steel satisfies one or more of the following criteria:
a. 0.02 wt %<Ti+Nb<0.12 wt %,
b. 0.7<Ti/N<3.5,
c. 0.5 wt %<Mo+W+Cr+Cu+Co+Ni<1.75 wt %,
d. 0.01 wt %<TiN+NbC+TiO/MgO<0.1 wt %,
e. average grain size of at least 2 microns,
   wherein the friction stir weldments have a prior austenite grain size of between 5 and 60 microns and less than 50 vol % of martensite-austenite constituent, and wherein the friction stir weldment strength is greater than the starting structural steel and the friction stir weldment toughness as measured by the crack tip opening displacement test at less than or equal to 0° C. is greater than 0.05 mm or by the Charpy V-notch impact test at less than or equal to 0° C. is greater than 40 J.

In one form, the friction stir weldments may have a prior austenite grain size of less than or equal to 60, 50, or 40, or 30, or 20, or 10, or 5 microns. In another form, the friction stir weldments may have a prior austenite grain size of greater than or equal to 2, or 5, or 7, or 10, or 15, or 20 microns. Prior austenite grain size during FSW may be controlled by such factors as the steel chemistry, initial base metal microstructure including grain size, FSW parameters, the heating rate just prior to the FSW stirring action and the cooling rate following the FSW stirring action. Several factors are influential in determining the prior austenite grain size, which controls the final room temperature grain size in a FSW joint. Dynamic and static recrystallization events are particularly influential factors. The magnitude of the highest temperatures reached within the stir zone during welding and the length of time at these temperatures are also particularly influential factors. The extent of grain growth before and after the highest temperature portion of the FSW thermo-mechanical cycle is also a factor and grain growth during such periods is controlled by the temperature, time at temperature, and the microstructure's resistance to grain growth.

With respect to grain refinement by dynamic recrystallization several factors control grain size including, but not limited to, the deformation temperature, plastic strain and the strain rate. In terms of importance, temperature may have a pronounced effect on grain size, followed by strain rate, and then strain. In this ranking, it is assumed that the plastic strain exceeds the critical strain for dynamic recrystallization. When the plastic strain exceeds the critical strain, it has no additional effect on the grain size while it has a pronounced effect if the plastic strain is less than the critical strain. Based on previous studies, plastic strain during FSW exceeds critical strain and, therefore, the strain is not considered a primary factor while the microstructure is near peak temperature and incurring the dominant FSW imposed strain. Strain rate has an effect on the grain size with the higher the strain rate, the finer the grain size. However, the effect of strain rate is less pronounced compared to temperature. It may take several orders of magnitude change in strain rate to produce an effect comparable to 10-20% change in temperature. Temperature and strain rate have opposite effects; therefore, decrease in temperature and higher strain rates promote finer (dynamically) recrystallized grain size, and vice versa.

When material is being subjected to elevated temperatures during FSW, the temperatures reached and the amount of time spent at high temperatures are significant factors affecting grain size. In past work by other investigators, the temperatures occurring during FSW of steels have been estimated at about 1000° C. It has been discovered that actual temperatures during the friction stir welding of steel can be as high as 1100° C., or 1200° C., or even 1300° C. depending on such variables as location within the weld region. These high temperatures necessitate novel approaches to control and optimize stir zone microstructures. Higher temperatures and longer times at higher temperatures increase grain size. According to FIG. 4, the temperatures of interest for grain growth are those at or above the ferrite-austenite critical temperature as schematically represented by the horizontal dotted line. This figure is schematic in nature and the temperature or temperature ranges that are significant for grain growth cannot be specifically represented by only a single value of temperature. For ferritic steels, the transition between room temperature microstructures like ferrite, bainite and martensite and the higher temperature structure of austenite occurs when the temperature is in the vicinity of the so called lower and upper critical temperatures, the A1 and A3, respectively, as is known to engineers skilled in the art of steel metallurgy. Grain growth during FSW occurs when the temperature of the material being welded is significantly above the A3 temperature (also referred to herein as the grain coarsening temperature differential) in conjunction with the time spent at this temperature being sufficiently long. Depending on steel microstructure and chemistry, the grain coarsening temperature differential may vary.

It is advantageous to determine grain coarsening temperatures to better understand how to select FSW parameters and conditions to ultimately control microstructural coarseness. As is known to those skilled in the art of steel metallurgy, and more particularly to those skilled in the art of high temperature steel processing, a series of experiments using a Gleeble or other thermal cycle simulator may be conducted to determine grain coarsening temperature for a specific steel. Hot torsion or hot compression experiments may be conducted whereby a series of samples are subjected to different peak temperatures from 900° C. to 1300° C., or even as high as 1400° C. The strain cycles may be chosen to simulate the process being investigated such as FSW. After reaching the prescribed peak temperature and holding the sample at this temperature for a specific length of time, the sample is then quenched. After quenching, the prior austenite grain size may be measured using standard metallographic techniques. A series of experiments whereby the peak temperature and time at peak temperature are systematically varied may be used to define grain coarsening temperatures and temperature differentials for any specific steel. As an alternative to the experimental approach, one of a number of modeling approaches may be used to predict the grain coarsening behavior of a steel. Albeit not as accurate as the aforementioned experimental techniques for specific steels, modeling predictions of grain coarsening behavior may be sufficiently accurate to provide the necessary information to select optimum welding conditions to control microstructural coarseness.

Grain growth during FSW can occur just prior to the high strain portion of the thermo-mechanical cycle, just after this cycle (as indicated in FIG. 4), or depending on the FSW parameters and the travel speed, it is also possible for some grain growth phenomena to occur during the highest temperature portion of the thermal cycle. Regardless of when it occurs, early, middle or late in the weld thermal cycle, the temperatures reached by the weld material (the stir zone) and the amount of time spent at these temperatures are dominant factors controlling grain size. These temperatures and times spent at temperatures above the A3 temperature may be controlled by selection of the FSW welding parameters and control of the temperature of the FSW surroundings. FSW welding parameters may include such items as weld travel speed, tool rotation speed and the forces placed on the FSW tool. Controlling the temperature of the surroundings may include local heating or cooling of the base material.

It has been discovered that if the stir zone temperature during FSW is greater than or equal to 100° C., or 200° C., or 300° C., or 400° C. above the A3 temperature and remains there for longer than a few seconds, grain growth may occur leading to a coarse grain size, high amounts of MA and other undesirable microstructural features, and ultimately degraded properties. The grain coarsening temperature differential is defined herein as the difference in temperature between the temperature of the stir zone during FSW and the A3 temperature of the steel being welded. It is desirable to limit the grain coarsening temperature differential depending on the service application of the friction stir weld. The grain coarsening temperature differential may be controlled to magnitudes of less than or equal to 100° C., or 200° C., or 300° C., or 400° C. depending on the application of the steel structure being produced by FSW and on the steel type being welded. For some general applications with non-demanding strength and toughness requirements, the grain coarsening temperature differential may be controlled to magnitudes less than or equal to 400° C. For other applications with more demanding mechanical property requirements, the grain coarsening temperature differential may be controlled to magnitudes less than or equal to 300° C., or 200° C., or 100° C. Hence, the range of grain coarsening temperature differentials may be from 0 to 400° C., or 0 to 300° C., or 0 to 200° C., or 0 to 100° C. depending upon the application.

With respect to time spent above the A3 temperature, depending on application of the structure being produced by FSW and the steel being welded, it may be sufficient to control the time to 10 seconds or less. In more demanding structural applications, it may be necessary to limit the time spent above the A3 temperature to 8 seconds or less. For higher toughness applications, the time spent above the grain coarsening temperature may need to be controlled to 6 seconds or less, or alternatively to 4 seconds or less. For structural applications with particularly stringent toughness requirements, the time spent above the grain coarsening temperature may be limited to 2 seconds or less, or alternatively 1 second or less.

Temperature and time (i.e., the welding thermal cycle) can be controlled by selection of variables such as FSW tool type, welding parameters, and secondary temperature control (e.g. preheat or enhanced cooling). As known to those skilled in the art of FSW, tool materials with higher coefficients of friction will generate higher temperatures than tools run with similar welding parameters, but with lower coefficients of friction. Higher rotational speeds applied to the FSW tool cause higher temperature. Slower weld travel speeds also create higher temperatures in the weld. Slower travel speeds also cause the weld material to remain at higher temperatures for longer times. Tool geometry effects such as a larger shoulder area can also create higher temperatures. Therefore, a variety of parameters are available to the welding engineer to alter the weld thermal cycle.

Welding travel speed and tool rotation speed are FSW process variables that are influential in controlling the weld thermal cycle. To avoid coarse grains, large amounts of MA, coarse microstructures, and degraded mechanical properties like low toughness, in the steel structures disclosed herein, FSW welding parameters should be carefully chosen and controlled to suit the application of the steel structure being fabricated by FSW. Too slow of a welding travel speed or too high of a tool rotation speed or any combination of these two, may result in unacceptable microstructure and mechanical properties.

For general applications, it may be sufficient to operate the FSW process with a travel speed of less than or equal to 5 inches per minute. For more demanding applications, the travel speed may need to be greater than or equal to 5 inches per minute, or greater than or equal to 10 inches per minute. For even more demanding applications where high toughness is desired, the welding travel speed may need to be greater than or equal to 15 inches per minute, or greater than or equal to 20 inches per minute. Hence the range of travel speeds of the FSW tool may range from 1 to 30 inches per minute, or 5 to 30 inches per minute, or 10 to 30 inches per minute, or 15 to 30 inches per minute, or 20 to 30 inches per minute depending upon the application.

With regard to tool rotation speed, for general applications it may be sufficient to operate the FSW process at a speed less than or equal to 800 rpm for the necessary microstructure and properties. For more demanding applications, the tool speed may need to be less than or equal to 600 rpm, or less than or equal to 500 rpm, or less than or equal to 400 rpm. For even more demanding applications where high toughness is desired, the tool speed may need to be less than or equal to 300 rpm, or less than or equal to 200 rpm. Hence, the range of tool rotation speeds of the FSW tool may range from 100 to 800 rpm, or 100 to 600 rpm, or 100 to 500 rpm, or 100 to 400 rpm, or 100 to 300 rpm, or 100 to 200 rpm depending upon the application. For some unique applications where it is desirable for productivity purposes to travel at high rates of travel speed, such as 15 inches per minute or above, it may be necessary to use high tool rotation rpms, such as 1000 rpm, or 2000 rpm, but the heat generated during such operation can be offset by the travel speed. By this offset, the stir zone microstructure can still be controlled using the novel approaches disclosed herein to obtain the target microstructure and properties.

The initial microstructure of the structural steel may not only have a fine grain size as small as 2 microns, but may also have fine dispersed particles within it. These fine dispersed particles may include, but are not limited to, nitrides (e.g. TiN, BN), carbides (e.g. NbC), carbonitrides (e.g. Nb(C,N), to Ti(C,N)), oxides (e.g. TiO, TiO₂, MgO, TiO/MgO), borides of transition elements (e.g. TiB₂, Fe₂B, Cr₂B), and combinations thereof. In one form of the structural steel for friction stir welding disclosed herein, the combined wt % of the TiN+NbC+TiO/MgO may range from greater than 0.01 wt % to less than 0.1 wt %, or alternatively greater than 0.03 wt % to less than 0.07 wt %. The starting microstructure of the structural steel influences the evolution of the final grain size with a finer initial grain size leading to faster recrystallization kinetics and to finer recrystallized grain size because the nucleation of recrystallization takes place preferentially at grain boundaries. The starting grain size of the base metal of the structural steel (also referred to herein as “starting structural steel” or “initial structural steel”) according to the novel FSW technology disclosed herein may be as small as 2 microns. It is not necessary to place an upper limit on base metal grain size because for steels with coarser grains, the novel FSW technology will produce a net refinement and display final prior austenite grain sizes of 60 microns or less depending on specific steel chemistry and welding conditions. The presence of fine dispersed particles (which are stable at FSW temperatures) in the starting structural steel microstructure retard grain growth at all stages of the thermo-mechanical cycle during FSW. Generally, the presence of these fine dispersed particles also correlates with finer grain size in the initial microstructure because these particles retard grain growth during the thermo-mechanical control processing (TMCP) used for plate making. Therefore, the combination of fine grain size and fine secondary phase dispersed particles in the starting structural steel microstructure are advantageous for the steel structures and methods of forming the steel structures disclosed herein.

Certain alloying elements, such as Ti, and Mg, may also be utilized to produce the fine dispersed particles in starting structural steel. Such fine dispersed particles existing inside an austenite grain may serve as nuclei for intergranular ferrite (IGF) or acicular ferrite (AF) as well as precipitation pinning to suppress grain growth. The IGF forms around the fine dispersed particles, and as a result, austenite grains are divided into finer grains which produce enhanced strength and toughness. In such steels, thus, the coarsening of austenite grains is suppressed, the IGF forms inside them, and as a consequence, the microstructure can be significantly refined.

The initial microstructure of the starting structural steel may also be absent of carbon segregated phases, such as for example pearlite colonies. The presence of coarse carbon segregated phases such as pearlite colonies can lead to low toughness in FSW joints because the high carbon concentration in such phases may enhance the formation of coarse MA constituent during the FSW. MA can form in the stir zone or in nearby regions such as the TMAZ or HAZ. In one form of the structural steel for friction stir welding disclosed herein, less than 25 vol %, or less than 20 vol %, or less than 15 vol %, or less than 10 vol % of pearlite may be included.

Another factor in controlling the final grain size is the grain growth during later stages of the FSW thermal cycle. Even when fine grains are produced by dynamic recrystallization, grain growth can be avoided either by pinning the grain boundaries with second phase particles or by drag exerted by solute elements. One or both these approaches may be required to refine the grain size. These approaches can be incorporated only through the modification of the base steel chemistry and processing.

For grain growth retardation by particle pinning, the second phase particles may be used, including, but not limited to, nitrides (e.g. TiN, BN), carbides (e.g. NbC), carbonitrides (e.g. Nb(C,N), Ti(C,N)), oxides (e.g. TiO, TiO₂, MgO, TiO/MgO), something happened to the formatting here borides of transition elements (e.g. TiB₂, Fe₂B, Cr₂B), and combinations thereof. These particles are chosen as a result of discovery of the peak temperatures occurring with friction stir welds. These particles are capable of boundary pinning at temperatures above 1000° C. For example, these particles are useful for peak temperatures of 1100° C., 1200° C., 1300°, or even 1400° C. For grain growth retardation by solute drag, solute elements that have different atomic size compared to iron may advantageous. Non-limiting exemplary solute elements are tungsten, molybdenum and niobium. Elements that do not have a large difference in atomic size compared to iron may provide a secondary effect on grain growth and include, but are not limited to, chromium, copper, vanadium, nickel, and combinations thereof.

Two factors have been identified that may be important in the design of particles for grain growth retardation. The first factor is the interparticle distance with larger interparticle distances allowing the grain boundaries to loop past and, therefore offer less resistance to grain growth. In contrast, small interparticle distances may prevent grain boundary looping, and hence provide increased resistance to grain growth. The interparticle distance of the particles may be less than 100, or 80, or 60, or 40, or 20, or 10 nm. The second phase particle size may be controlled by the chemistry and processing during steel making. For instance, the interparticle spacing of the TiN particles may be decreased by a low Ti/N ratio, i.e., lower than the stoichiometric ratio of nitrides (3.42), while a higher ratio provides coarser particles with larger interparticle distance.

The second factor that may determine grain growth retardation in the design of second phase particles is their stability at FSW temperatures. Particles that are less stable may coarsen, thereby increasing the interparticle distance while particles that are more stable may not coarsen. A non-limiting exemplary list of the relative stability of several particles useful for welding applications in steel is as follows:

BN>TiO₂>TiN>TiB₂>NbC>VC

This list is not exhaustive and, for example, could be expanded to include the many carbides and carbonitrides of Nb or V.

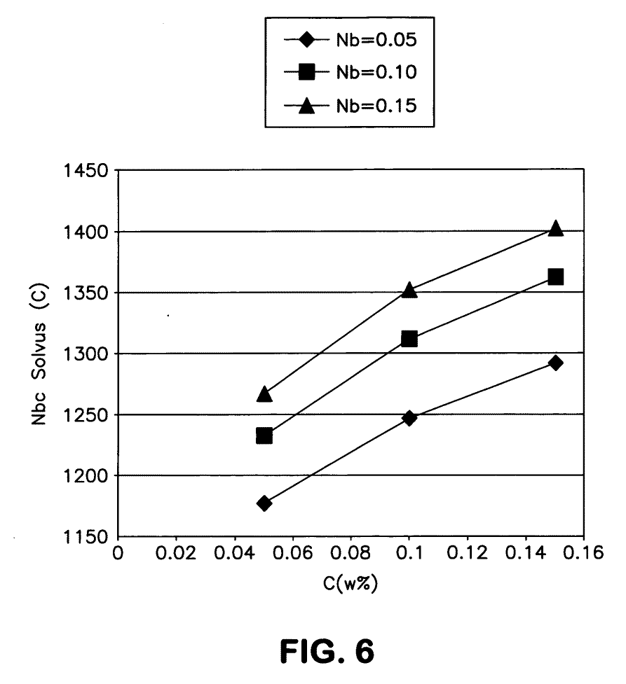

The concentration of the pinning element may impact the stability at the FSW temperature and it is important that the particles are stable at temperatures above 1000° C. FIG. 6 depicts the calculated solubility of NbC in steels at elevated temperatures. As can be seen from the plot, niobium concentration in the range of 0.1 to 0.15 wt % may provide stable particles at FSW temperatures.

Retardation of growth can also be accomplished by incorporation of specific solute elements in the steel. Microalloying elements, such as for example, Nb, Ti, V, Mo, and W, in solid solution retard most diffusion controlled processes in steel. This retardation is stronger with a bigger difference in the atom size of any specific element compared to that of Fe atom. Nb, Mo and W may be advantageous microalloying elements in this context. However, elements such as Nb, Mo, W may also promote the formation of MA constituents, which in high concentrations decreases the toughness. Therefore, these elements can not be added in high concentrations. A secondary set of elements which do not promote MA constituent can be added to provide modest retardation to grain boundaries movement. Examples of these elements include, but are not limited to, Cu, Cr, Co, Ni and Mn.

The solute drag effect may be significantly enhanced by a combination of alloying elements. Combined addition of Nb and B may lead to strong synergistic effect on solute drag due to the formation of (Nb, B) complexes at high temperature. The presence of such complexes at the austenite grain boundaries may also decrease the boundary moving velocity by enhancing the solute drag force of the Nb atoms.

Based on the aforementioned discussions, the following ranges of chemistry in the starting structural steel may decrease grain growth by solute drag and particle pinning.

| | General Range | Advantageous Range |
|---|---|---|
| | (in wt %) | (in wt %) |
| Carbon | 0.02-0.2 | 0.04-0.15 |
| Chromium | 0-2 | 0.15-0.5 |
| Cobalt | 0-2 | 0.2-0.5 |
| Nickel | 0-2 | 0.1-0.5 |
| Niobium | 0-0.2 | 0.04-0.12 |
| Molybdenum | 0-1.0 | 0.15-0.5 |
| Tungsten | 0-0.5 | 0.1-0.25 |

In addition, the following elements may be added to the starting structural steel to decrease grain growth by particle pinning.

| | General Range | Advantageous Range |
|---|---|---|
| | (in wt %) | (in wt %) |
| Vanadium | 0-0.2 | 0.05-0.12 |
| Titanium | 0-0.2 | 0.04-0.15 |
| Boron | 0-0.05 | 0.0005-0.005 |
| Nitrogen | 0-0.05 | 0.002-0.01 |
| Magnesium | 0-0.5 | 0.001-0.015 |

Within these additional elements, boron may be advantageous in decreasing grain growth in the structural steel at amounts of 0 to 500 ppm, or 5 to 250 ppm, or 5 to 100 ppm, or 5 to 50 ppm.

Within the aforementioned ranges of chemistry for the starting structural steel, one or more of the following additional criteria must be met to obtain friction weld performance that produces both adequate strength and toughness in the weldment:

| | General Range | Advantageous Range |
|---|---|---|
| | (in wt %) | (in wt %) |
| Ti + Nb | 0.02-0.12 | 0.07-0.10 |
| Ti/N | 0.07-3.5 | 0.8-1.5 |
| Mo + W + Cr + Cu + Co + Ni | 0.5-1.75 | 1.0-1.5 |
| TiN + NbC + TiO/MgO | 0.01-0.1 | 0.03-0.07 |

Niobium may provide both particle pinning as well as solute drag. The solute drag mechanism is invoked at high temperatures which the niobium carbonitride has partially dissolved and niobium is in solid solution. At lower temperatures niobium would provide particle pinning through Nb(C,N).

The steel structure with the friction stir weldments disclosed herein also includes less than 50, or 40, or 30, or 25, or 20, or 15 or 10 vol % of the martensite-austenite (MA) constituent in order to obtain acceptable strength and toughness. For the range of structural steel chemistries and prior austenite grain sizes disclosed, the formation of martensite-austenite constituents within this range may be affected by the chemistry and the cooling rate of the weld, particularly through the temperature range of 900-200° C. where MA formation takes place. Slower cooling rates generally promote the formation of higher temperature transformation products, which results in higher carbon partitioning producing brittle phases such as martensite-austenite constituents.

The balance of microstructural constituents in FSW welds may include a combination of martensite, lower bainite, fine granular bainite, degenerate upper bainite, martensite-austenite constituent and other bainitic ferrite phases including acicular ferrite. The FSW weld microstructure may include polygonal ferrite or possible pearlite under conditions of slower cooling and/or lean chemistry. The formation of MA may also be controlled by adjusting the steel chemistry. Therefore, the amount of the various constituents, including MA, in FSW welds may be controlled with a combination of chosen steel chemistries and control of weld cooling rates.

Another factor influencing the strength and toughness of the steel structures disclosed herein is the presence of low levels of inclusions and impurity elements in the structural steel for friction stir welding. Inclusions may be present in the steel from the steel making operation or they may arise from tool wear contamination or from contamination on the joint surfaces, prior to FSW. The tool technology has advanced to the point that contamination from the tools is generally minimal, but the welding engineer is still responsible for ensuring adequate tool durability through proper qualification. Inclusions due to poor weld joint preparation may be avoided by careful pre-weld cleaning procedures. Yet another aspect of the steel structures disclosed herein is that structural steels with tailored chemistry and good cleanliness may ensure good grain boundary cohesion for high toughness. An embrittlement of the grain boundaries may result in intergranular fracture. This fracture appearance is often correlated with the interstitial alloying elements, such as phosphorus and sulfur content of the structural steel. In one form, the starting structural steel may include less than 100 ppm of sulfur and less than 150 ppm of phosphorous. In another form, the starting structural steel may include less than 75 ppm of sulfur and less than 125 ppm of phosphorous. In yet another form, the starting structural steel may include less than 50 ppm of sulfur and less than 75 ppm of phosphorous. The temperature excursions experienced during FSW may exacerbate the susceptibility to grain boundary embrittlement due to larger prior austenite grain size and more susceptible microstructure to embrittlement than that of base structural steel.

According to the features of steels disclosed herein intended for optimal FSW compatibility and optimum strength and toughness, it is advantageous to choose steels with low levels of non-metallic inclusions such as manganese sulfide, silicon oxide, aluminum oxide, magnesium oxide, calcium oxide, titanium nitride and the various spinels and other oxides that occur in steels. This is particularly important when the final weld microstructure is predominantly martensite and/or bainite. Such weld microstructures are particularly sensitive to the presence of non-metallic inclusions from the standpoint of brittle fracture resistance. To meet demanding toughness requirements, it is necessary to limit the inclusion content of the weld, which for FSW is dependant on the base metal. In one form of the starting structural steel for optimum friction stir welds, the steel may include less than 100 inclusions per square millimeter as determined from observation on a polished cross section. This requirement relates to inclusions that are 0.5 microns or larger, such inclusions being the most detrimental to toughness. In another form, the starting structural steel may include less than 75 inclusions per square millimeter, or less than 50 inclusions per square millimeter, or less than 40 inclusions per square millimeter, or less than 30 inclusions per square millimeter. For the most demanding applications requiring high toughness, the inclusions per square millimeter should be less than 20. Again these inclusion requirements relate to inclusions that are 0.5 microns or larger.

For optimum formulation of a starting structural steel for FSW, lower or higher overall oxygen contents can be utilized, depending on the application and toughness requirements, but only within a reasonable range. In the case that oxygen based particles are used for grain boundary pinning, a balance must be achieved in the overall oxygen content of the steel. Too little oxygen will create an insufficient number of particles, whereas too much oxygen will lead to too many particles and low toughness. An upper limit of oxygen for most applications according to the technology disclosed herein would be 200 ppm. This could be reduced to 150 ppm or 100 ppm if the application demanded more stringent toughness requirements. If the boundary pinning particles are not oxygen based, then conventional steel melting practices will generally produce oxygen contents not lower than 5 ppm. Therefore, optimal oxygen content may range from 5 ppm to 200 ppm, depending on the application and toughness requirements.

From the foregoing, to enhance FSW joint toughness and strength, refinement of grain size, targeted microstructural constituents, and limitations on impurities may be advantageous. These may be accomplished with the synergistic combination of initial structural steel chemistry, initial structural steel microstructure, including grain size and FSW processing and cooling conditions.

In another form of the steel structures disclosed herein, the friction stir weldments may have an austenite grain size of less than 40 microns and less than 25 vol % of martensite-austenite constituent. In yet another form of the steel structures disclosed herein, the friction stir weldments may have an austenite grain size of less than 30 microns and less than 15 vol % of martensite-austenite constituent. In still yet another form of the steel structures disclosed herein, the friction stir weldments may have an austenite grain size of less than 20 microns and less than 10 vol % of martensite-austenite constituent.

The two or more structural steel components used in forming the steel structure with friction stir weldments may be composed of API (American Petroleum Institute) Pipe Specification 5L pipe grades chosen from X50, X52, X60, X65, X70, X80, X90, X100 and X120 or higher strength steel. The wall thickness of the pipe may range from 3.2 mm to 38.1 mm, or 6.4 mm to 31.8 mm, or 12.7 to 25.4 mm. In another form, the wall thickness of the pipe may range from or 25.4 to 50 mm.

The friction stir weldments formed using the structural steels within the range of chemistries and microstructures described above yield the combination of acceptable strength and toughness. In one form, the friction stir weldment strength is greater than structural steel and the friction stir weldment toughness as measured by the crack tip opening displacement test at less than or equal to 0° C. is greater than 0.05 mm or by the Charpy V-notch impact test at less than or equal to 0° C. is greater than 40 J. In this form, the crack tip opening displacement at less than or equal to 0° C. may be alternatively greater than 0.1 mm, or 0.15 mm, or 0.2 mm, or 0.25 mm, or 0.3 mm. In this form, the friction stir weldment toughness as measured by the Charpy V-notch impact test at less than or equal to 0° C. may be greater than 75 J, or 100 J, or 125 J, or 150 J, or 175 J, or 200 J.

### Exemplary Method of Welding Structural Steel:

One form of the method for welding structural steel disclosed herein includes providing two or more structural steel components produced by conventional melting practices, wherein the chemistry and grain size of the starting structural steel satisfies one or more of the following criteria:
a) 0.02 wt %<Ti+Nb<0.12 wt %,
b) 0.7<Ti/N<3.5,
c) 0.5 wt %<Mo+W+Cr+Cu+Co+Ni<1.75 wt %,
d) 0.01 wt %<TiN+NbC+TiO/MgO<0.1 wt %,
e) average grain size of at least 2 microns,
   subjecting the faying surfaces of the structural steel components to be welded to friction stir welding under conditions sufficient to form friction stir weldments, wherein the friction stir weldments have a prior austenite grain size of between 5 and 60 microns and less than 50 vol % of martensite-austenite constituent, and wherein the friction stir weldment strength is greater than the starting structural steel and the friction stir weldment toughness as measured by the crack tip opening displacement test at less than or equal to 0° C. is greater than or equal to 0.05 mm or by the Charpy V-notch impact test at less than or equal to 0° C. is greater than 40 J.

In one form of the method for welding structural steel disclosed herein, the friction stir weldments formed may have a prior austenite grain size of less than or equal to 60, or 50, or 40, or 30, or 20, or 10, or 5 microns. In another form of the method disclosed herein, the friction stir weldments may have a prior austenite grain size of greater than or equal to 2, or 5, or 10, or 15, or 20 microns. As previously described, prior austenite grain size during FSW may be controlled by the steel chemistry, initial base metal microstructure including grain size, as controlled by steel processing, FSW processing parameters and the cooling rate following FSW.

The method for welding structural steel disclosed herein should not only have a fine grain size, but may also have fine dispersed particles within it. These fine dispersed particles may include, but are not limited to, nitrides (e.g. TiN, BN), carbides (e.g. NbC), carbonitrides (e.g. Nb(CN), Ti(C,N)), oxides (e.g. TiO, TiO₂, MgO, TiO/MgO), borides of transition elements (e.g. TiB₂), and combinations thereof. In one form of the method for welding structural steel disclosed herein, the combined wt % of the TiN+NbC+TiO/MgO may range from greater than 0.01 wt % to less than 0.1 wt %, or alternatively greater than 0.03 wt % to less than 0.07 wt %.

The method for welding structural steel disclosed herein should also have the absence of carbon segregated phases, such as for example pearlite colony. In one form of the method for welding structural steel disclosed herein, less than 25 vol %, or less than 20 vol %, or less than 15 vol %, or less than 10 vol % of pearlite may be included.

The method for welding structural steel disclosed herein produces friction weldments with less than 50, or 40, or 30, or 25, or 20, or 15 or 10 vol % of the martensite-austenite (MA) constituent in order to obtain acceptable strength and toughness.

The method for welding structural steel disclosed herein may utilize structural steels composed of API (American Petroleum Institute) Pipe Specification 5L pipe grades chosen from X50, X52, X60, X65, X70, X80, X90, X100 and X120 or higher strength steel. These structural steels should have low levels of inclusions and impurity elements as previously described. In one form, the structural steel should include less than 100 ppm of sulfur and less than 150 ppm of phosphorous as impurity elements. In another form, the structural steel should include less than 75 ppm of sulfur and less than 125 ppm of phosphorous as impurity elements. In yet another form, the structural steel should include less than 50 ppm of sulfur and less than 75 ppm of phosphorous as impurity elements.

The methods for welding structural steel disclosed herein utilize the friction stir welding in combination with the structural steel compositions described above. The FSW process conditions that should be controlled to form suitable weldments include, but are not limited to, one or more of the following: welding travel speed of the friction stir weld tool, rotational speed of the friction stir weld tool, the torsion loads applied to the friction stir weld tool, down force load or the translational load on the friction stir weld tool, and the cooling rate of the weldment.

The welding travel speed of the friction stir weld tool may range from 1 to 30, or 5 to 25, or 10 to 20 inches per minute. The rotational speed of the friction stir weld tool may range from 100 to 700, or 200 to 600, or 300 to 500 rpms. The down force load or the translational load on the friction stir weld tool may be greater than or equal to 1000 lb_{f} and less than or equal to 25,000 lb_{f}, or greater than or equal to 5000 lb_{f} and less than or equal to 20,000 lb_{f}, or greater than or equal to 10000 lb_{f} and less than or equal to 15,000 lb_{f}. After the weldment is formed, the cooling rate of the weldment may range from 10° C. per second to 400° C. per second, or 50° C. per second to 300° C. per second, or 100° C. per second to 200° C. per second.

The methods for welding structural steel disclosed herein using the structural steels within the range of chemistries and microstructures described above yield the combination of acceptable strength and toughness. In one form, the friction stir weldment strength is greater than structural steel and the friction stir weldment toughness as measured by the crack tip opening displacement test at less than or equal to 0° C. is greater than 0.05 mm or by the Charpy V-notch impact test at less than or equal to 0° C. is greater than 40 J. In this form, the crack tip opening displacement at less than or equal to 0° C. may be alternatively greater than 0.1 mm, or 0.15 mm, or 0.2 mm, or 0.25 mm, or 0.3 mm. In this form, the friction stir weldment toughness as measured by the Charpy V-notch impact test at less than or equal to 0° C. may be greater than 75 J, or 100 J, or 125 J, or 150 J, or 175 J, or 200 J.

### Applications:

In one aspect, the friction stir methods disclosed herein are useful in welding and repairing cast irons and carbon steel components used structural applications. In another aspect the friction stir welding methods disclosed herein are useful in welding and repairing structural steels. These structural steels may be linepipe steels used in the oil and gas industry, including, but not limited to, API (American Petroleum Institute) Pipe Specification 5L pipe grades chosen from X50, X52, X60, X65, X70, X80, X90, X100 and X120 or higher strength steel. The wall thickness of the pipe may range from 3.2 mm to 38.1 mm, or 6.4 mm to 31.8 mm, or 12.7 to 25.4 mm, or 25.5 to 50 mm.

In yet another aspect, the friction stir methods disclosed herein are particularly useful in welding and repairing plain carbon and alloy steels. Exemplary, but not limiting, plain carbon and alloy steels include, AISI 1010, 1020, 1040, 1080, 1095, A36, A516, A440, A633, A656, 4063, 4340, 6150 and other AISI grades, including high strength grades. Other exemplary carbon low alloy steels include ASTM grades A285, A387, A515, A516, A517 and other ASTM grades of carbon low alloy steels.

The friction stir methods disclosed herein may be used to form welds, for example as spot welds, butt welds and T-joints, as well as to repair weld areas. More particularly, the FSW methods may be used to join and repair/treat respectively structures and structural steel components associated with the oil and gas industry. The joining via FSW may be performed either in a manufacturing facility such as a steel mill where the components are made or in the field of fabrication where the components (such as pipelines) are assembled. The repair treatment via FSP is generally made in the field. The resultant structures exhibit superior strength and toughness, and in many instances, may be joined and repaired/treated at a lower cost.

The steel structures and methods of making such steel structures disclosed herein are suitable for forming and repairing/treating structures in oil and gas exploration, production and refining applications. FSW is particularly advantageous for forming spot welds and butt welds of tubular structural steel components in these types of applications.

Exemplary, but non-limiting, steel structures in the oil and gas exploration, production, refining industry where the FSW methods of making disclosed herein find application are pipeline weld areas, steel catenary risers (SCR) and top tensioned risers (TTR) weld areas, threaded components, oil drilling equipment weld areas (i.e. two sections of a deep water oil drill string), liquefied natural gas (LNG) and pressurized LNG (PLNG) container weld areas, riser/casing joints, and well head equipment.

In oil and gas upstream applications, the methods of making steel structures disclosed herein are suitable for joining and repairing structures and components used in natural gas transportation and storage type applications. In particular, the methods of making steel structures disclosed herein may be utilized to enable gas transportation technologies ranging from pipelines, compressed natural gas (CNG), pressurized liquefied natural gas (PLNG), liquefied natural gas (LNG) and other storage/transportation technologies. In one form in natural gas transportation and storage type applications, the methods of making steel structures disclosed herein may be used for the joining/processing of pipelines, flow lines, gathering lines, expansion loops, and other transmission lines. In another form in natural gas transportation and storage type applications, the methods of making steel structures disclosed herein disclosed herein may be used for joining/processing of materials made of carbon steels, and structural steels. In yet another form in natural gas transportation and storage type applications, the methods of making steel structures disclosed herein may be used for the joining/processing of LNG, CNG, and PLNG storage and/or transportation structures. This includes modular LNG structures, shipping vessels, transferring components and pipelines, and related technologies.

In oil and gas exploration and production applications, the methods of making steel structures disclosed herein also may be utilized for joining and repairing various structures used for oil and gas well completion and production. These structures include, but are not limited to, offshore and onshore production structures, oil pipelines, oil storage tanks, casing/tubing, completion and production components, cast structure to flow line connections, subsea components, downhole tubular products (e.g. OCTG), topsides and related structures, umbilicals, tender and supply vessels, and flare towers. More particularly, exemplary offshore production structures include jacketed platforms, mobile offshore drilling units and related production components like casings, tendons, risers, and subsea facilities. Mobile offshore drilling units include, but are not limited to, semi-submersibles and jack-up rigs, tension leg platforms (TLPs), deep draft caisson vessels (DDCVs), compliant towers, floating production, storage and offloading (FPSO) vessels, floating storage and offloading (FSO) vessels, ships, tankers and the like. Exemplary subsea components include, but are not limited to, manifold systems, trees, and BOPs. Exemplary topsides and related structures include deck superstructures, drilling rigs, living quarters, helidecks, and related structures. It should be understood that FSW may be used to form the welds comprising such structures and components and FSP may be used to repair and treat the welds or joints comprising such structures.

In downstream applications, the methods of making steel structures disclosed herein are suitable for joining and repairing structures and components used in refining and chemical plants. The steel structures and methods of making such steel structures disclosed herein provide advantages in the refining and chemicals plant applications through, inter alia, repair of components/structures, dissimilar metal joining, joining of steel structures and joining of difficult to weld materials, such as cast iron. These applications include, but are not limited to, cast iron, heat exchanger tubes and low and high-temperature process and pressure vessels. Exemplary low and high-temperature process and pressure vessels include steam cracker tubes, steam reforming tubes, and refinery structures and components. Exemplary materials suitable for the disclosed FSW technology include such corrosion resistant materials as 13% Cr steel grades, duplex stainless steel and superduplex stainless steel.

The following are examples of the present disclosure and are not to be construed as limiting with respect to the scope of the invention or the scope of the claims.

### EXAMPLES

The following examples further illustrate the advantageous performance of the steel structures and methods of making such steel structures disclosed herein. In all the examples, test plates were sectioned in half along the rolling direction and prepared for a butt joint. Oxide scale was removed by sand grinding followed by degreasing with methanol. Argon gas atmosphere was used to prevent oxidation during weld cycle and to prolong tool life, although the argon shielding is not a critical factor in the novel FSW technology disclosed herein.

FSW was carried out at 3.5 inch per minute welding speed, 170 rpm tool rotation using W—Re tool. CTOD toughness measurement was conducted according to ASTM E1820 and/or BS 7448 Parts 1, 2, and 4. Specimen geometry was the standard B×2B (a/W=0.5), single edge notch bend (SENB) configuration. For the friction stir welds, the fatigue precracks were positioned in various locations within the stir zone and the thermo-mechanical affected zone (TMAZ). The precracks were oriented in the through-thickness (L-T) orientation. The test temperatures ranged from ambient to −60° C.

Metallographic samples for optical, scanning electron microscopy (SEM), transmission electron microscopy (TEM), and microhardness investigations were prepared from weldments using standard metallographic procedures followed by etching with a 2% nital solution.

### Example 1

API X80 grade linepipe steels, about ½″ thickness, were used in the FSW studies. The chemical compositions of the steels (wt %) are listed in Table 1. In the following examples, the CTOD values listed are low bound results.

TABLE 1
Chemical composition of the steel (wt %):

| | | | | | | | | | | | | | Prior γ | | |
|---|---|---|---|---|---|---|---|---|---|---|---|---|---|---|---|
| | | | | | | | | | | | | | grain | | |
| | | | | | | | | | | | | | size | CTOD | |
| Steel | C | Mn | Si | Cu | Ni | V | Nb | Al | Cr | Mo | Ti | N | (μm) | (mm) | Comments |
| Steel 1 | 0.05 | 1.52 | 0.17 | 0.26 | 0.14 | 0 | 0.10 | 0.03 | 0.26 | 0 | 0.01 | 0.004 | 20~30 | 0.10 | Inventive 1 |
| Steel 2 | 0.07 | 1.91 | 0.36 | 0.19 | 0.21 | 0.07 | 0.06 | 0.04 | 0.16 | 0.08 | 0.00 | 0.005 | 40~60 | 0.015 | Comparative 1 |

Steel 1 and Steel 2 with different Nb+Ti contents were chosen to demonstrate the effect on the fracture toughness. Steel 1 with higher Nb+Ti content has superior toughness than Steel 2. Steel 2 also displayed significantly larger (40-60 μm) prior austenite grains than Steel 1.

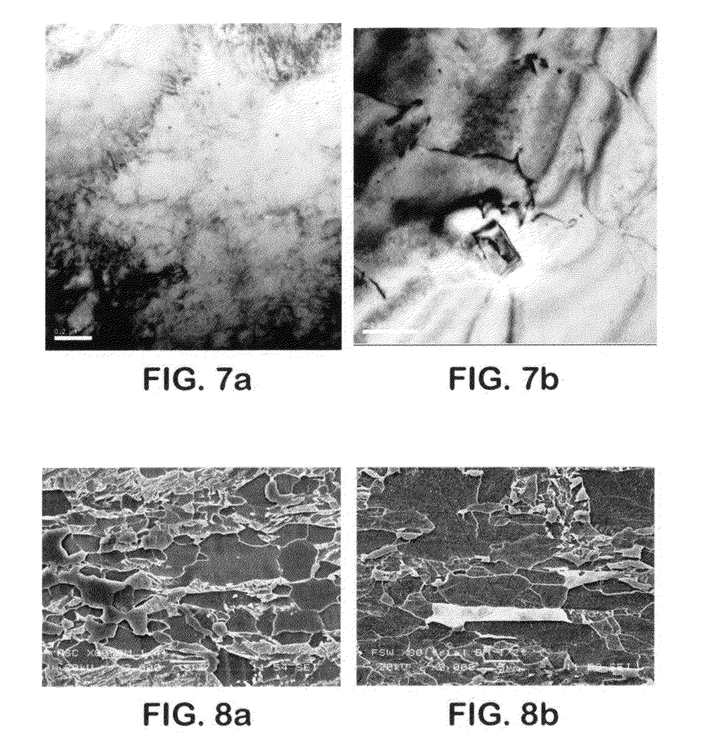

FIG. 7 shows transmission electron microscope images showing the presence of the high density, fine (˜10 nm) precipitates of NbC and/or Nb(C,N) in Steel 1. In contrast, low density, coarser (˜200 nm) precipitates of primarily Ti(C,N) precipitates were present in Steel 2.

### Example 2

High strength linepipe steels with about ½″ thickness were used in the FSW studies. The chemical compositions of the steels (wt %) are listed in Table 2.

TABLE 2
Chemical composition of the steel (wt %):

| | | | | | | | | | | | | | | CTOD | |
|---|---|---|---|---|---|---|---|---|---|---|---|---|---|---|---|
| Steel | C | Mn | Si | Cu | Ni | V | Nb | Al | Cr | Mo | Ti | B | N | (mm) | Comments |
| Steel 3 | 0.06 | 1.88 | 0.25 | 0.18 | 0.16 | 0 | 0.03 | 0.00 | 0.02 | 0.21 | 0.01 | 0.0001 | 0.0053 | 0.11 | Inventive 2 |
| Steel 2 | 0.07 | 1.91 | 0.36 | 0.19 | 0.21 | 0.07 | 0.06 | 0.04 | 0.16 | 0.08 | 0.00 | 0.0000 | 0.005 | 0.015 | Compara. 1 |

Steel 3 (inventive) and Steel 2 (comparative) were investigated to study the effect of the initial grain size and microstructure of the steel plates to mechanical properties of FSW joints. As mentioned previously, the initial steel plate grain size reflects the effect of second phase particles as the result of the TMCP process.

FIG. 8 shows scanning electron micrographs of the base metal comparing the microstructure between Steel 3 (inventive) and Steel 2 (comparative). In Steel 2, the base metal microstructure was dominated by primary ferrite with grain sizes ranging from about 5 μm to about 25 μm. A minor fraction of second phase was also present in the microstructure and these regions contained mixtures of martensite, bainite, and pearlite colonies. On the other hand, Steel 3 shows the base metal microstructure with finer initial grain size. The base metal was composed of primary ferrite phase with grain sizes ranging from about 5 μM to about 15 μm. The second phase of the Steel 3 was predominantly granular bainite (GB) and martensite while pearlite colonies were absent.

Applicants have attempted to disclose all forms and applications of the disclosed subject matter that could be reasonably foreseen. However, there may be unforeseeable, insubstantial modifications that remain as equivalents. While the present disclosure has been described in conjunction with specific, exemplary forms thereof, it is evident that many alterations, modifications, and variations will be apparent to those skilled in the art in light of the foregoing description without departing from the spirit or scope of the present disclosure. Accordingly, the present disclosure is intended to embrace all such alterations, modifications, and variations of the above detailed description.

All patents, test procedures, and other documents cited herein, including priority documents, are fully incorporated by reference to the extent such disclosure is not inconsistent with this invention and for all jurisdictions in which such incorporation is permitted.

When numerical lower limits and numerical upper limits are listed herein, ranges from any lower limit to any upper limit are contemplated. All numerical values within the detailed description and the claims herein are also understood as modified by “about.”

What is claimed is:

1. A steel structure comprising: two or more structural steel components produced by conventional melting or secondary refining practices and friction stir weldments bonding faying surfaces of the components together,
wherein the chemistry and grain size of the starting structural steel satisfies one or more of the following criteria:
a) 0.02 wt %<Ti+Nb<0.12 wt %,
b) 0.7<Ti/N<3.5,
c) 0.5 wt %<Mo+W+Cr+Cu+Co+Ni<1.75 wt %,
d) 0.01 wt %<TiN+NbC+TiO/MgO<0.1 wt %,
e) average grain size of at least 2 microns,
wherein the friction stir weldments have a prior austenite grain size of between 5 and 60 microns and less than 50 vol % of martensite-austenite constituent, and
wherein the friction stir weldment strength is greater than the starting structural steel and the friction stir weldment toughness as measured by the crack tip opening displacement test at less than or equal to 0° C. is greater than or equal to 0.05 mm or by the Charpy V-notch impact test at less than or equal to 0° C. is greater than 40 J.

2. The steel structure of claim 1, wherein the starting structural steel includes less than 100 ppm of sulfur and less than 150 ppm of phosphorous.

3. The steel structure of claim 2, wherein the starting structural steel includes less than 50 ppm of sulfur and less than 75 ppm of phosphorous.

4. The steel structure of claim 1, wherein the starting structural steel includes pearlite at less than 25 vol %.

5. The steel structure of claim 4, wherein the starting structural steel includes pearlite at less than 15 vol %.

6. The steel structure of claim 1, wherein the friction stir weldments have a prior austenite grain size of between 5 and 40 microns and less than 25 vol % of martensite-austenite constituent.

7. The steel structure of claim 6, wherein the friction stir weldments have a prior austenite grain size of between 5 and 20 microns and less than 10 vol % of martensite-austenite constituent.

8. The steel structure of claim 1, wherein the two or more structural steel components are API (American Petroleum Institute) Pipe Specification 5L pipe grades chosen from X50, X52, X60, X65, X70, X80, X90, X100 and X120.

9. The steel structure of claim 1, wherein the two or more structural steel components are plain carbon and alloy steels chosen from AISI grades 1010, 1020, 1040, 1080, 1095, A36, A516, A440, A633, A656, 4063, 4340, 6150, and ASTM grades A285, A387, A515, A516, A517.

10. The steel structure of claim 1, wherein the friction stir weldment toughness as measured by the crack tip opening displacement test at less than or equal to 0° C. is greater than or equal to 0.1 mm.

11. The steel structure of claim 10, wherein the friction stir weldment toughness as measured by the crack tip opening displacement test at less than or equal to 0° C. is greater than or equal to 0.2 mm.

12. The steel structure of claim 1, wherein the friction stir weldment toughness as measured by the Charpy V-notch impact test at less than or equal to 0° C. is greater than 75 J.

13. The steel structure of claim 12, wherein the friction stir weldment toughness as measured by the Charpy V-notch impact test at less than or equal to 0° C. is greater than 150 J.

14. The steel structure of claim 1, wherein the starting structural steel further includes from 5 ppm to 50 ppm of boron.

15. The steel structure of claim 1, wherein the starting structural steel includes less than 100 non-metallic inclusions per square millimeter of an average size of 0.5 microns or larger.

16. The steel structure of claim 15, wherein the starting structural steel includes less than 50 non-metallic inclusions per square millimeter of an average size of 0.5 microns or larger.

17. The steel structure of claim 16, wherein the starting structural steel includes less than 20 non-metallic inclusions per square millimeter of an average size of 0.5 microns or larger.

18. A method for welding structural steel comprising:
providing two or more structural steel components produced by conventional melting or secondary refining practices, wherein the chemistry and grain size of the starting structural steel satisfies one or more of the following criteria:
a. 0.02 wt %<Ti+Nb<0.12 wt %,
b. 0.7<TUN<3.5,
c. 0.5 wt %<Mo+W+Cr+Cu+Co+Ni<1.75 wt %,
d. 0.01 wt %<TiN+NbC+TiO/MgO<0.1 wt %,
e. average grain size of at least 2 microns,
subjecting the faying surfaces of the structural steel components to be welded to friction stir welding under conditions sufficient to form friction stir weldments,
wherein the friction stir weldments have a prior austenite grain size of between 5 and 60 microns and less than 50 vol % of martensite-austenite constituent, and
wherein the friction stir weldment strength is greater than starting structural steel and the friction stir weldment toughness as measured by the crack tip opening displacement test at less than or equal to 0° C. is greater than or equal to 0.05 mm or by the Charpy V-notch impact test at less than or equal to 0° C. is greater than 40 J.

19. The method of claim 18, wherein the starting structural steel includes less than 100 ppm of sulfur and less than 150 ppm of phosphorous.

20. The method of claim 19, wherein the starting structural steel includes less than 50 ppm of sulfur and less than 75 ppm of phosphorous.

21. The method of claim 18, wherein the starting structural steel includes pearlite at less than 25 vol %.

22. The method of claim 21, wherein the starting structural steel includes pearlite at less than 15 vol %.

23. The method of claim 18, wherein the conditions sufficient to form friction stir weldments are chosen from at least one of the temperature of the stir zone during welding, time spent at the temperature of the stir zone during welding, welding travel speed of the friction stir weld tool, the rotational speed of the friction stir weld tool, the torsion loads applied to the friction stir weld tool, the down force load or the translational load on the friction stir weld tool, and the cooling rate of the weldment.

24. The method of claim 23, wherein the welding travel speed of the friction stir weld tool ranges from 1 to 30 inches per minute.

25. The method of claim 24, wherein the welding travel speed of the friction stir weld tool ranges from 10 to 30 inches per minute.

26. The method of claim 25, wherein the welding travel speed of the friction stir weld tool ranges from 15 to 30 inches per minute.

27. The method of claim 23, wherein the rotational speed of the friction stir weld tool ranges from 100 to 800 rpm.

28. The method of claim 27, wherein the rotational speed of the friction stir weld tool ranges from 100 to 500 rpm.

29. The method of claim 28, wherein the rotational speed of the friction stir weld tool ranges from 100 to 200 rpm.

30. The method of claim 23, wherein the down force load or the translational load on the friction stir weld tool is greater than or equal to 1000 lb_{f} and less than or equal to 25,000 lb_{f}.

31. The method of claim 23, wherein the cooling rate of the weldment ranges from 10° C. per second to 400° C. per second.

32. The method of claim 18, wherein the friction stir weldments have a prior austenite grain size of between 5 and 20 microns and less than 10 vol % of martensite-austenite constituent.

33. The method of claim 18, wherein the two or more structural steel components are API (American Petroleum Institute) Pipe Specification 5L pipe grades chosen from X50, X52, X60, X65, X70, X80, X90, X100 and X120.

34. The method of claim 18, wherein the two or more structural steel components are plain carbon and alloy steels chosen from AISI grades 1010, 1020, 1040, 1080, 1095, A36, A516, A440, A633, A656, 4063, 4340, 6150, and ASTM grades A285, A387, A515, A516, A517.

35. The method of claim 18, wherein the friction stir weldment toughness as measured by the crack tip opening displacement test at less than or equal to 0° C. is greater than or equal to 0.2 mm.

36. The method of claim 18, wherein the friction stir weldment toughness as measured by the Charpy V-notch impact test at less than or equal to 0° C. is greater than 150 J.

37. The method of claim 18 wherein the starting structural steel further includes from 5 ppm to 50 ppm of boron.

38. The method of claim 18, wherein the starting structural steel includes less than 100 non-metallic inclusions per square millimeter of an average size of 0.5 microns or larger.

39. The method of claim 38, wherein the starting structural steel includes less than 50 non-metallic inclusions per square millimeter of an average size of 0.5 microns or larger.

40. The method of claim 39, wherein the starting structural steel includes less than 20 non-metallic inclusions per square millimeter of an average size of 0.5 microns or larger.

41. The method of claim 23, wherein the grain coarsening temperature differential is less than or equal to 400° C.

42. The method of claim 41, wherein the grain coarsening temperature differential is less than or equal to 300° C.

43. The method of claim 42, wherein the grain coarsening temperature differential is less than or equal to 200° C.

44. The method of claim 43, wherein the grain coarsening temperature differential is less than or equal to 100° C.

45. The method of claim 41, wherein the time at the grain coarsening temperature differential is less than or equal to 10 seconds.

46. The method of claim 42, wherein the time at the grain coarsening temperature differential is less than or equal to 8 seconds.

47. The method of claim 43, wherein the time at the grain coarsening temperature differential is less than or equal to 6 seconds.

48. The method of claim 44, wherein the time at the grain coarsening temperature differential is less than or equal to 2 seconds.
